(19) United States
(12) Patent Application Publication
(10) Pub. No.: US 2026/0129508 A1
(43) Pub. Date: May 7, 2026

(54) METHODS, ARCHITECTURES, APPARATUSES AND SYSTEMS FOR SERVICE ENABLER ARCHITECTURE LAYER DATA DELIVERY TRAFFIC SYNCHRONIZATION IN MOBILE NETWORKS

(71) Applicant: InterDigital Patent Holdings, Inc., Wilmington, DE (US)

(72) Inventors: Michel Roy, Candiac (CA); Michael Starsinic, Newtown, PA (US); Xavier De Foy, Kirkland (CA); Kevin Di Lallo, Laval (CA)

(21) Appl. No.: 18/939,912

(22) Filed: Nov. 7, 2024

(51) Int. Cl. H04W 28/02; H04W 36/02

(52) U.S. Cl. CPC H04W 28/0278; H04W 36/023

(57) ABSTRACT

A method, implemented in a WTRU is described herein. The method may include sending configuration information to a WTRU. The configuration information may indicate the WTRU to send reporting information to the network element about a buffering event related to a traffic flow. The method may include receiving the reporting information from the WTRU indicating that (1) the buffering event related to the traffic flow may have occurred at the WTRU and (2) the buffering event may be associated with a buffering condition being satisfied at the WTRU. The method may include determining a corrective action associated with the traffic flow based on the reporting information to prevent the buffering condition from being satisfied. The method may include performing the corrective action associated with the traffic flow.

### TECHNICAL FIELD

The present disclosure is generally directed to the fields of communications, software and encoding, including methods, architectures, apparatuses, and systems directed to service enabler architecture layer data delivery traffic synchronization in mobile networks.

### BACKGROUND

The service enabler architecture layer for data delivery (SEALDD) is a framework designed to facilitate efficient and flexible data delivery in distributed systems and applications. It focuses on improving (e.g., optimizing) data flow between service providers and consumers. Embodiments described herein have been designed with the foregoing in mind.

### SUMMARY

Methods, architectures, apparatuses, and systems directed to SEALDD traffic synchronization in mobile networks are described herein. In an embodiment, a network element is described. The network element may include circuitry including any of transmitter, a receiver, a processor, and a memory. The network element may be configured to send configuration information to a wireless transmit/receive unit (WTRU). In various embodiments, the configuration information may indicate the WTRU to send reporting information to the network element about a buffering event related to a traffic flow. The network element may be configured to receive the reporting information from the WTRU indicating that (1) the buffering event related to the traffic flow may have occurred at the WTRU and (2) the buffering event may be associated with a buffering condition being satisfied at the WTRU. The network element may be configured to determine a corrective action associated with the traffic flow based on the reporting information to prevent the buffering condition from being satisfied. The network element may be configured to perform the corrective action associated with the traffic flow.

In an embodiment, a method implemented in a network element is described. The method may include sending configuration information to a WTRU. In various embodiments, the configuration information may indicate the WTRU to send reporting information to the network element about a buffering event related to a traffic flow. The method may include receiving the reporting information from the WTRU indicating that (1) the buffering event related to the traffic flow may have occurred at the WTRU and (2) the buffering event may be associated with a buffering condition being satisfied at the WTRU. The method may include determining a corrective action associated with the traffic flow based on the reporting information to prevent the buffering condition from being satisfied. The method may include performing the corrective action associated with the traffic flow.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example SEALDD functional architecture;

FIG. 3 is a diagram illustrating an overview example method for SEALDD traffic synchronization;

FIG. 4 is a diagram illustrating an example method for performing SEALDD traffic synchronization configuration;

FIG. 5 is a diagram illustrating an example procedure for performing SEALDD traffic synchronization monitoring and coordination; and

FIG. 6 is a diagram illustrating an example method for SEALDD traffic synchronization in mobile networks.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

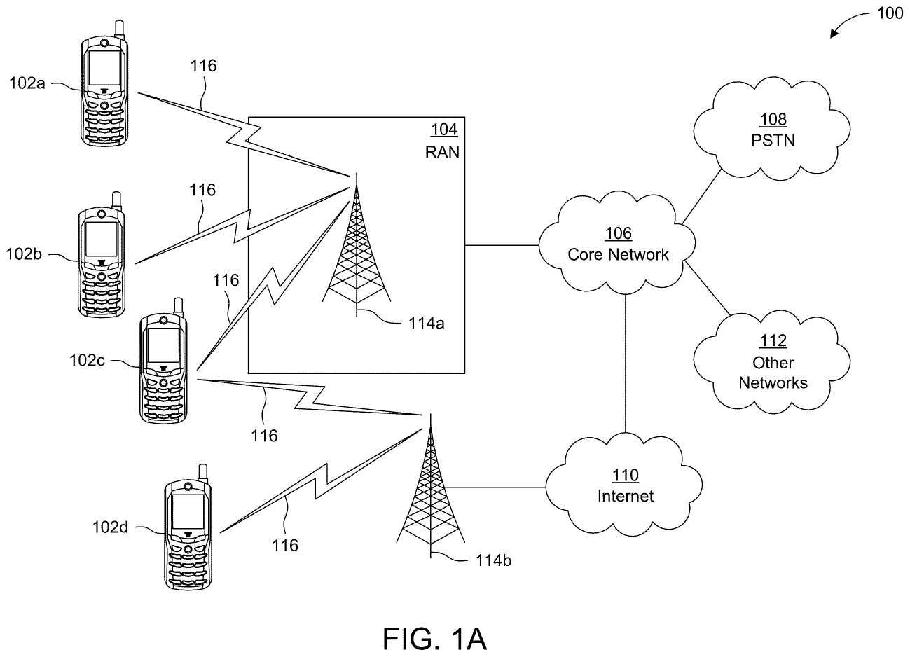

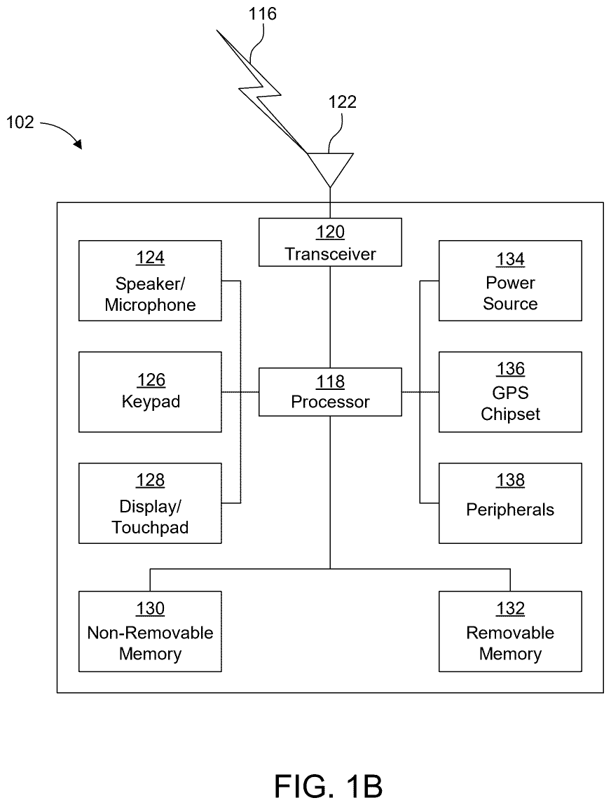

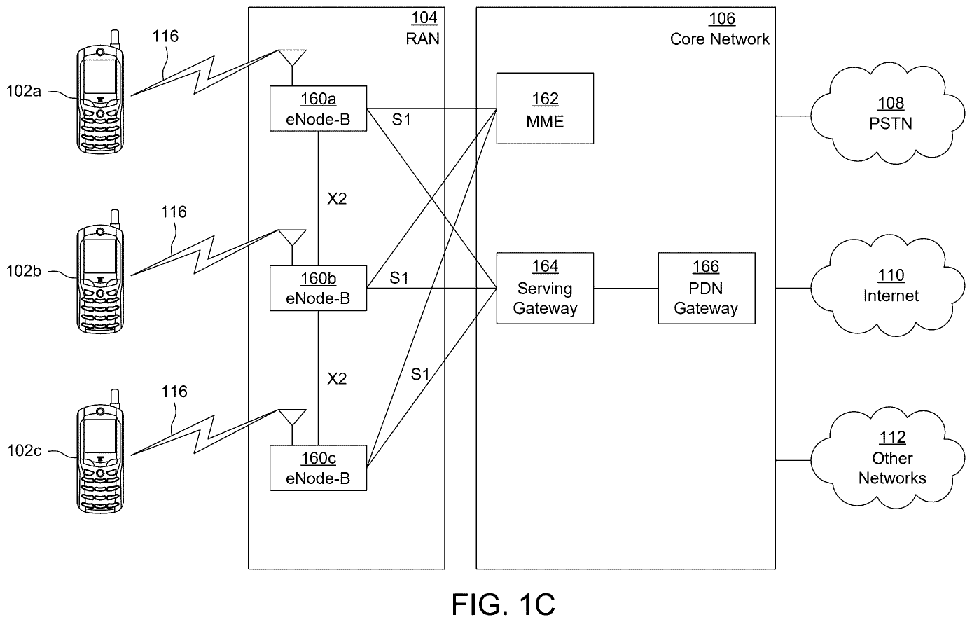

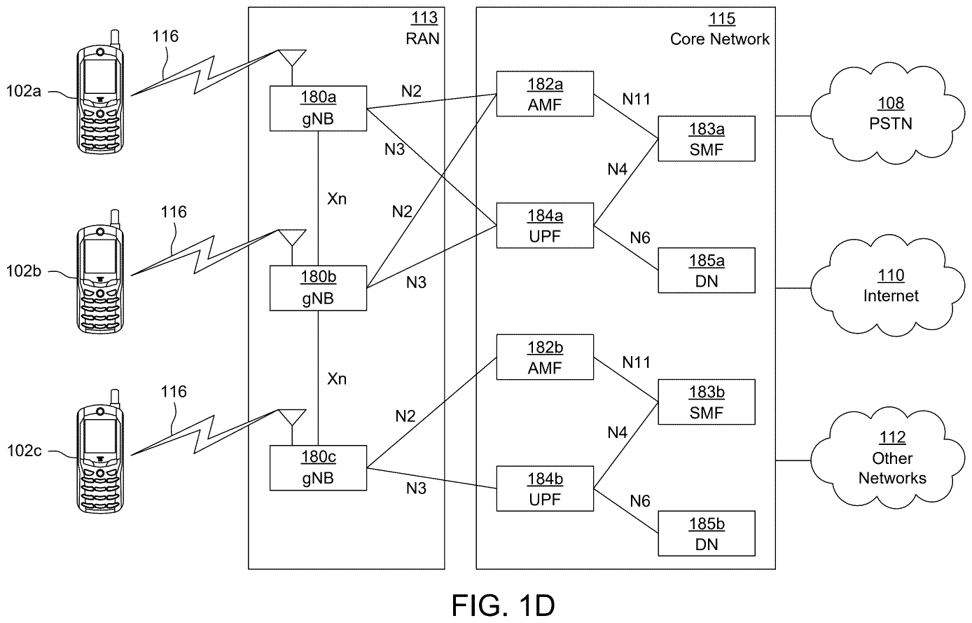

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a new radio (NR) Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Throughout embodiments described herein the terms “base station”, “network”, “cell”, and “gNB”, collectively “the network” may be used interchangeably to designate any network element such as e.g., a network element acting as a serving base station. Embodiments described herein are not limited to gNBs and are applicable to any other type of base stations.

For the sake of clarity, satisfying, failing to satisfy a condition, and configuring condition parameter(s) are described throughout embodiments described herein as relative to a threshold (e.g., greater, or lower than) a (e.g., threshold) value, configuring the (e.g., threshold) value, etc. For example, satisfying a condition may be described as being above a (e.g., threshold) value, and failing to satisfy a condition may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “the WTRU may be configured with a set of parameters” is equivalent or may be used interchangeably with “the WTRU may receive configuration information (e.g., from another network element (e.g., gNB)) indicating a set of parameters”. Throughout embodiments described herein, the expressions “the WTRU may report something”, and “the WTRU may be configured to report something”, is equivalent or may be used interchangeably with “the WTRU may transmit (e.g., reporting) information indicating something”. Throughout embodiments described herein, the expression “the WTRU may provide (/be provided) with a set of parameters (/something)” is equivalent or may be used interchangeably with “the WTRU may transmit (/receive) information indicating a set of parameters (/something)”.

In embodiments described herein, “a” and “an” and similar phrases are to be interpreted as “one or more” and “at least one”. Similarly, any term which ends with the suffix “(s)” is to be interpreted as “one or more” and “at least one”. The term “may” is to be interpreted as “may, for example”.

A symbol “/” (e.g., forward slash) may be used herein to represent “and/or”, where for example, “A/B” may imply “A and/or B”.

In embodiments described herein, “list of”, “set of” and “one or more of” may be used interchangeably.

In embodiments described herein, “identity” and “identifier” may be used interchangeably to refer to how a network element (or a WTRU) may be identified.

In embodiments described herein, a network element may refer to any kind of device including computing resources and networking capabilities, that may be connected to a network. The terms network element and node may be used interchangeably. A network element may be any kind of network infrastructure device and or a WTRU. The architecture depicted at FIG. 1B for a WTRU 102 may be applicable more generally to any kind of network element.

### Service Enabler Architecture Layer for Data Delivery

The service enabler architecture layer for data delivery (SEALDD) is a framework designed to facilitate efficient and flexible data delivery in distributed systems and applications. It focuses on improving (e.g., optimizing) data flow between service providers and consumers.

The data delivery framework may encompass various mechanisms for data transmission, including any of streaming real-time data flows that may allow continuous delivery of data without delays, batch processing for efficiently handling large volumes of data at scheduled intervals and event-driven delivery for responding to specific events or triggers to deliver data.

The architecture emphasizes the importance of QoS parameters such as any of latency, reliability, and throughput and provides mechanisms to monitor and adjust these parameters based on application requirements.

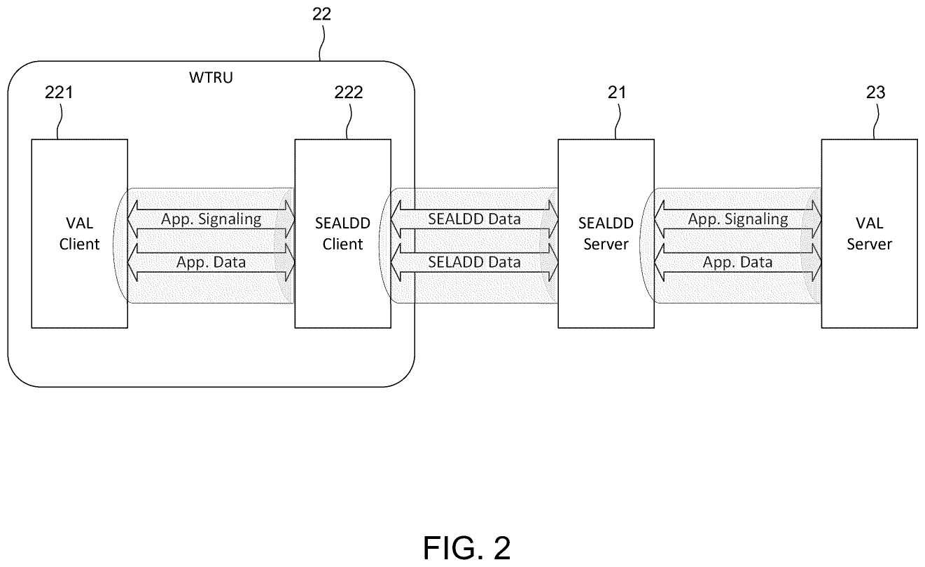

FIG. 2 is a diagram illustrating an example SEALDD functional architecture.

A functional summary of the SEALDD functional architecture is described herein.

The SEALDD server 21 may act as an application function (AF) e.g., trusted or not trusted to interact with the control plane of the fifth generation core network (5GC) via the service based architecture as described in third generation partnership project (3GPP) technical specification (TS) 23.501 V19.1.0 or via the 5GC northbound application programming interface (API) via common API framework (CAPIF) as described in 3GPP TS 23.222 V19.3.0.

For uplink traffic, a vertical application layer (VAL) client 221 located on a WTRU 22 may send application data traffic and signaling to a co-located SEALDD client 222 (e.g., on the same WTRU) to use SEALDD functionality. The SEALDD client 222 may process the VAL client data and may convert it to SEALDD data traffic before transfer to a SEALDD server 21. The SEALDD server 21 may restore the application data traffic and signaling and may send it to a VAL server 23. The VAL client traffic may be sent over different flows to the SEALDD server 21.

For downlink traffic, a VAL server 23 may send application data traffic to a SEALDD server 21 to obtain SEALDD services. After application data and signaling may be processed by the SEALDD server 21, the application data and signaling traffic may be converted to SEALDD data traffic and transferred to the SEALDD client 222 of the WTRU 22. The SEALDD client 222 may restore the application data traffic and may send it to VAL client 221. The VAL server traffic may be sent over different flows to the SEALDD client 222 of the WTRU 22.

The SEALDD client 222 may interact with the SEALDD server 21 to establish application layer data transport path. Through this path, the SEALDD server 21 and client 222 may provide data transport service capabilities such as any of data plane packet processing (e.g., any of packet duplication, elimination, and transport coordination), data forwarding, data caching, background data transfer, etc. to support the VAL server 23 and VAL client 221 requirements for data delivery.

### Data Boost

Data boost is described herein. Carrying media flows may be challenging for wireless networks, e.g., for applications with high-throughput and low latency requirements, such as any of video conferencing and extended reality (XR). Wireless networks may implement techniques to improve network capacity and energy efficiency, and to reduce the impact of packet losses on user experience. An example of such technique is “data boosting”, where the sending application may mark packets that are to be handled with a higher QoS.

The data boost feature (which may also be referred to as expedited forwarding) may be configured by an AF by providing, for example, along with a request for an AF session with QoS, two sets of QoS requirements (normal and expedited). As a result, the 5G system may create two policy and charging control (PCC) rules, respectively corresponding to the two sets of QoS requirements. The PCC rules may be used to configure a PDU session with a normal QoS flow and an expedited QoS flow. During the lifetime of the service, the UPF may forward downlink (DL) traffic on the normal QoS flow e.g., by default, unless it may identify the expedited transfer indication in a PDU, in which case the UPF may transmit the PDU over the expedited QoS flow. In an example, when reflective QoS is used, the WTRU may send UL on the same QoS flow as the most recent DL PDU if the reflective QoS indication is set.

The data boost feature may be extended to use more than two QoS flows. For example, multiple QoS requirements corresponding to multiple PDU urgency indication values may be configured by the AF and may be used to configure PCC rules including the more than two QoS requirements and urgency values. The PCC values may be used to configure a PDU session with several QoS flows, (e.g., each) corresponding to different QoS requirements and urgency values. During the lifetime of the service, the UPF may identify the value of the urgency indication in a DL PDU and may transmit the PDU over to the QoS flow corresponding to the urgency value.

Embodiments are described herein with data boosting as an example of user plane-based indication influencing the selection of the QoS treatment of PDUs. Data boosting may refer to any of data boosting and extended data boosting. Embodiments described herein are not limited to data boosting (or extended data boosting). Any technique based on a user plane indication influencing the selection of the QoS treatment of PDUs is compatible with embodiments described herein. The user plane indication may refer to as an urgency indication and may be any of an expedited transfer indication and an urgency indication.

### Packet Alignment for XR Applications

Packet alignment for extended reality (XR) flows refers to the timing and synchronization of data packets as they may be transmitted over a network to support XR applications, which may include any of virtual reality (VR), augmented reality (AR), and mixed reality (MR) experiences.

XR applications may be highly sensitive to any of latency, jitter, and data loss, as any delay or misalignment can degrade user experience by causing any of visual distortions, motion sickness, and lag in response times.

The alignment of packets in XR flows may allow to ensure virtual experiences to be realistic, immersive, and responsive. Proper alignment may allow to prevent visual and auditory inconsistencies, may reduce (e.g., minimize) latency, and may support a high-quality experience. Given the sensitivity of XR applications to network issues, packet alignment may allow to meet the performance demands of real-time, immersive applications.

Five concepts for packet alignment of XR flows are described herein.

A first concept is related to temporal synchronization between different XR data flows. XR experiences may require strict temporal synchronization between different data flows (e.g., any of audio, video, haptic, sensory data, etc.) to create a cohesive virtual environment. Packet alignment may ensure that (e.g., all) flows may be temporally synchronized such that data packets from different flows may be concurrently delivered in the correct order and with low (e.g., minimal) delay. This may avoid desynchronization between visual frames, audio and haptic/sensory data which can disrupt immersion.

A second concept is related to XR data flows latency. Based on the real-time nature of XR applications, XR flows may require ultra-low latency to ensure real-time responsiveness. Packet alignment may allow to reduce (e.g., minimize) latency by organizing and delivering packets promptly to meet real-time requirements. In XR flows, (e.g., even) minor delays can lead to noticeable lag, affecting user interaction with virtual objects or the environment.

A third concept is related to XR data flows packet ordering. In some network environments, data packets may arrive out of order, which may disrupt XR experiences. Packet alignment may include mechanisms to ensure packets arrive in the correct sequence, or reorder them, to maintain a smooth and coherent data stream for XR applications.

A fourth concept is related to XR data flows jitter. Variation in packet arrival times (e.g., jitter) may disrupt XR applications, causing frame drops and/or skips. Packet alignment may reduce (e.g., minimize) jitter by ensuring that packets are evenly spaced and arrive at consistent intervals, allowing a stable visual and auditory experience in XR.

A fifth concept is related to QoS for XR data flows. Packet alignment for XR flows may require QoS mechanisms that may prioritize XR data over other types of traffic on the network. This prioritization may ensure that XR packets may experience low (e.g., minimal) delays and interruptions, supporting a seamless experience.

### Terminology

Embodiments are described herein with a SEALDD server as an example of network element for SEALDD traffic synchronization in mobile networks. Embodiments described herein are not limited to a SEALDD server and may be applicable to any kind of network element.

Embodiments are described herein with a WTRU as an example of client device interacting with the SEALDD server. Embodiments described herein are not limited to a WTRU and may be applicable to any kind of client device.

Embodiments are described herein with XR traffic as an example of data traffic to be transmitted and synchronized over the network. Embodiments described herein are not limited to XR traffic and may be applicable to any kind of data traffic.

Embodiments are described herein based on considering a WTRU comprising a VAL client and a SEALDD client. Any feature described with reference to any of the VAL client and the SEALDD client (such as the SEALDD/VAL client performing an operation) may be equally applicable to the WTRU (e.g., the WTRU performing the operation described as being performed by the SEALDD/VAL client).

Embodiments are described herein with a buffering related event as an example of event to be detected by a WTRU for triggering sending a report. Embodiments described herein are not limited to buffering related events and may be applicable to any kind of event that may be detected by a WTRU to trigger a report. In embodiments described herein, the terms buffering event, buffering related event, flow alignment event, synchronization event, flow synchronization monitoring event, collectively “event” may be used interchangeably to refer to an event that may be detected to trigger a report.

In embodiments described herein, “report” and “reporting information” may be used interchangeably.

### SEALDD Traffic Synchronization

In 3GPP Rel-19, the study of XR traffic support at the application layer concluded that XR traffic flows may need to be synchronized when using SEALDD technology.

To perform XR flow synchronization, a SEALDD client residing on a WTRU may perform synchronization by buffering downlink XR flow(s) for maintaining packet alignment between XR flows such that the packets provided to a vertical application using SEALDD may be (e.g., temporally) aligned.

The term misalignment is used herein to designate a case where the media buffering size (e.g., in seconds) is misaligned between different components of a multiplexed application flow. For example, at a given point in time, a misaligned buffer may hold two and a half seconds of audio data and three seconds of video data.

Misalignment may occur at different time scale. In an example, slow timescale misalignments (e.g., several seconds and up) can be corrected through the application and/or through adaptions of the QoS treatment of the flows. For example, if video tends to be a bit late and audio a bit fast, the first QoS treatment can be improved (e.g., with a lower packet delay budget (PDB)) and the second QoS treatment can be decreased. In another example, fast timescale misalignment (e.g., less than a second) can be corrected using faster and more temporary mechanisms, such as using the data boost feature. For example, if the video buffer is emptying fast, then temporarily boosting the flow may help solving a temporary network congestion situation, or a temporary slowdown at the application layer.

Synchronization mechanisms may present at least the following two challenges.

A first challenge may be related to the amount of memory (e.g., needed and/or available) at the WTRU (e.g., at the SEALDD client) for buffering. The memory used for buffering XR packets is not infinite and may be limited (e.g., capped) via configuration to prevent the WTRU to run out of available memory due to buffering. A configured memory cap may allow to accommodate a (e.g., certain) level of de-synchronization. A configured memory cap may not allow to accommodate sudden large levels of de-synchronization. For example, XR flow de-synchronization between two flows may be such that the buffering mechanism cannot perform re-synchronization, and a buffering overflow may happen.

SEALDD XR flow synchronization mechanisms may be enhanced to determine or predict the level of de-synchronization acceptable and allowed for a particular XR flow(s). The SEALDD XR flow synchronization mechanisms may be enhanced for taking corrective actions when determined or predicted de-synchronization levels are unsupported.

A second challenge may be related to mobile network traffic delivery mechanisms. The mobile network may deliver traffic based on configured QoS information. As such, if XR flows belonging to the same XR session are de-synchronized such that their synchronization is drifting apart, the synchronization mechanisms may start buffering packets to perform re-synchronization. Over time, the buffering may accumulate such that the WTRU may run out of buffering memory and buffering overflow may happen.

XR flow synchronization mechanisms may be enhanced to detect drifting de-synchronization for a particular XR flow and may be enabled to take corrective actions when de-synchronization drifting de-synchronization is detected.

Embodiments described herein provide methods for detecting burst and/or drift de-synchronization of XR flows and methods for taking corrective actions beyond buffering traffic for SEALDD traffic synchronization.

### SEALDD Traffic Synchronization Enhancements Overview

A SEALDD server may receive an indication to use traffic flow synchronization. The SEALDD server may configure data boost for the SEALDD flow. For example, when configuring data boost for the SEALDD flow, the SEALDD server may send information to the 5GC about the SEALDD flow and expected QoS values to be used when the data boost functionality may become enabled. In an example, the SEALDD server may not enable the data boost functionality from the beginning (e.g., immediately).

The SEALDD server may configure a SEALDD client to send reports to the SEALDD server related to buffering events and related to a traffic flow. For example, the SEALDD server may send configuration information to a WTRU, the configuration information indicating the WTRU to send reporting information to the network element about a buffering event related to (e.g., associated with) a traffic flow.

A first example of a buffering event may be the SEALDD client detecting that more than an amount of data is stored in a buffer for more than an amount of time. A second example of a buffering event may be the SEALDD client detecting that less than an amount of data is stored in a buffer for more than an amount of time. More generally, a buffering event may be associated with a buffering condition being satisfied at the WTRU.

The SEALDD server may receive a report from the SEALDD client. The report may indicate that a buffering event may have occurred related to a traffic flow. The report may (e.g., in some systems) include any of (i) an indication that a buffer may be over-utilized (e.g., may have crossed a first (e.g., high) threshold), (ii) an indication that a buffer may be under-utilized (e.g., may have crossed a second (e.g., low) threshold) and (iii) a criticality indication. In a first example, the buffering condition may be satisfied at the WTRU based on an amount of data stored at the WTRU being higher than a first (e.g., high) threshold, e.g., for an amount of time. In a second example, the buffering condition may be satisfied at the WTRU based on an amount of data stored at the WTRU being lower than a second (e.g., low) threshold e.g., for an amount of time. In an example, the configuration information may indicate any of the first threshold, the second threshold and the amount of time.

The SEALDD server may use information in a report (e.g., reporting information) to determine a corrective action to eliminate a buffer over-utilization or under-utilization condition (e.g., to prevent the buffering condition from being satisfied). The SEALDD server may perform any of the following actions:

The SEALDD server may determine whether the buffering event for a flow is over-utilizing a buffer or under-utilized a buffer. For example, it may be determined whether the buffering event corresponds to a buffer over utilization or to a buffer underutilization at the WTRU.

The SEALDD server may determine if the mechanism to resolve the buffering event (e.g., the corrective action) may be traffic influence via QoS or via data boost.

If the corrective action is determined to be traffic influence via QoS, the SEALDD server may determine a new QoS (e.g., delay) value to resolve the buffer over-utilizing or under-utilizing and may invoke an API of a network exposure function (NEF) or policy control function (PCF) to request the traffic flow to be associated with the determined new QoS (e.g., delay) value. The new QoS (e.g., delay) value may be used to configure a PDB value or a requested 5GS delay value in the API invocation.

If the corrective action is determined to be traffic influence via data boost, the SEALDD server may mark SEALDD flow PDUs with an urgency indication to (e.g., rapidly) adjust (e.g., reduce) the delay of a traffic flow associated with a delay value.

### SEALDD XR Traffic Synchronization Overview

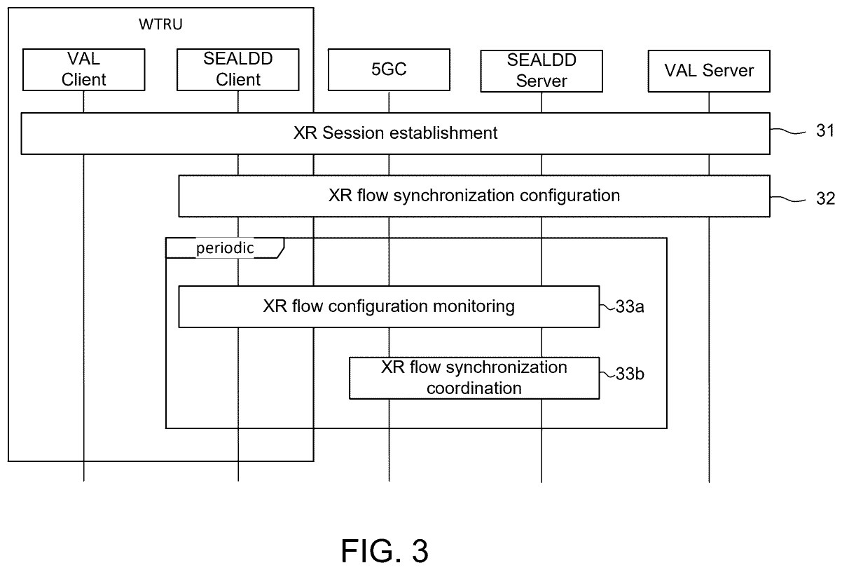

FIG. 3 is a diagram illustrating an overview example method for SEALDD XR traffic synchronization.

As shown at 31, a VAL client located on a WTRU may establish a XR session with a VAL server. The VAL client with SEALDD capabilities may use capabilities provided by the WTRU co-located SEALDD client to establish the session. The session establishment may include any of session authorization, capability exchange and configuration related to the requested session at the VAL layer and at the SEALDD layer. Session establishment shown at 31 may correspond to procedures described in clause 9.2.2 of 3GPP TS 23.433 V19.3.0 for SEALDD connection establishment.

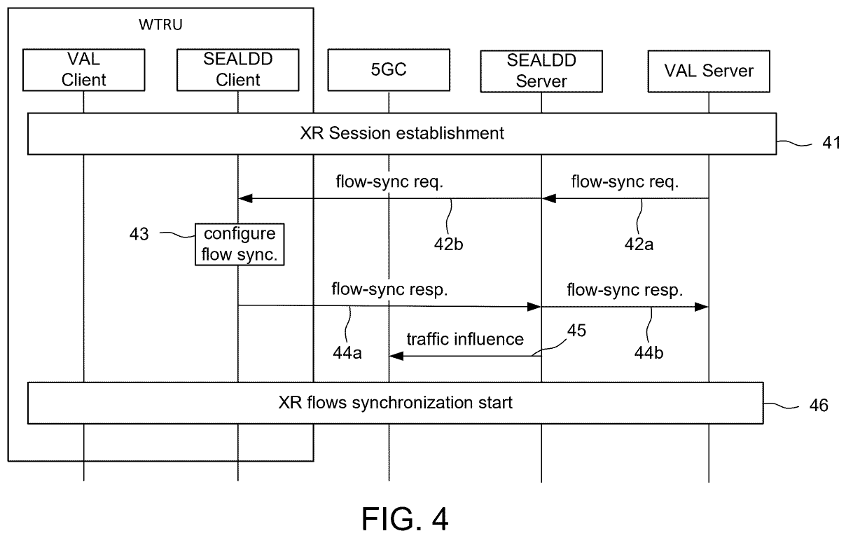

As shown at 32, the VAL server with SEALDD capabilities may communicate with the SEALDD server to indicate that the session may be an XR session and that XR flow synchronization may be requested (e.g., required). The SEALDD server may configure XR flow synchronization as described on FIG. 4 with the SEALDD client and may configure QoS with the 5GC for the specified flows. XR flow synchronization configuration is described further herein together with the description of FIG. 4.

As shown at 33a, the SEALDD server may configure XR flow monitoring with the SEALDD client and may (e.g., periodically) monitor XR flow synchronization reports. XR flow synchronization reports may provide (e.g., information indicating) a status on XR flow synchronization and may provide (e.g., information indicating) analytics related to XR flows buffering at the SEALDD client.

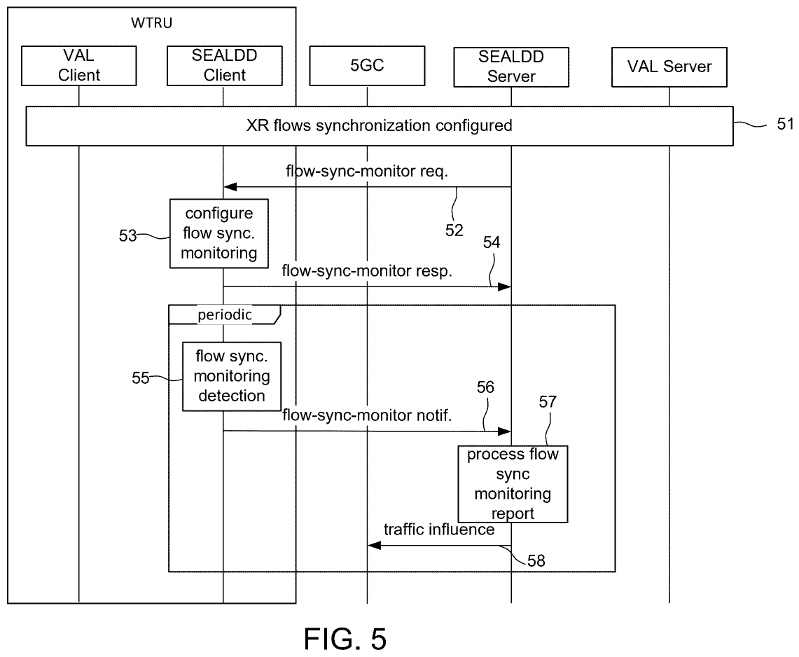

As shown at 33b, the SEALDD server may consider analytics related to XR flow buffering, may re-evaluate QoS parameters for XR flows based on buffering information and may coordinate with the 5GC to adapt the QoS of XR flows accordingly. QoS parameters for XR flows re-evaluation and coordination with the 5GC is described further herein together with the description of FIG. 5.

### SEALDD XR Traffic Synchronization Configuration

A procedure is described herein, allowing a XR application to configure flow synchronization for the SEALDD transport. This may include configuring SEALDD for supporting the data boost feature provided by the underlying mobile network.

FIG. 4 is a diagram illustrating an example method for performing SEALDD XR traffic synchronization configuration.

As shown at 41, an XR session may have been established between the VAL client and VAL server. The XR session may be carried over a SEALDD connection between the SEALDD client and SEALDD server. Examples of SEALDD connection establishment are described in clause 9.2.2 of 3GPP TS 23.433 V 19.3.0.

As shown at 42a, the VAL server may send a (e.g., flow synchronization) request to the SEALDD server. As shown at 42b, the SEALDD server may send a (e.g., flow synchronization) request to the SEALDD client. The requests may include information about the XR session such as any of WTRU information, XR traffic information and XR flow synchronization requirements.

In an example, WTRU information may include any of WTRU identifiers (e.g., generic public subscription identifier (GPSI)), the SEALDD client identifier and the VAL client identifier. XR traffic information may include (e.g., for a (e.g., every) XR flow of the XR session) any of the five-tuple information, information about the media type and QoS requirements. XR flow synchronization requirements may indicate whether a XR flow may be to be synchronized and may further indicate any of the expected XR flow characteristics (e.g., any of data rate, periodicity, burst sizes, etc.) and the tolerance for synchronization. Any of the XR flow characteristics and synchronization tolerance may be used by the SEALDD server and/or client to configure flow synchronization.

The SEALDD server may determine expected buffering sizes (e.g., needs) based on any of the XR flow characteristics and synchronization tolerance and may include the determined expected buffering sizes (e.g., needs) in the request shown at 42b sent to the SEALDD client. In an example, the SEALDD server may determine QoS requirements for the individual XR flows considering (e.g., based on) any of the XR traffic QoS requirements and XR flow synchronization requirements. The determined QoS requirements may be included in the request sent to the SEALDD client as shown at 42b. The determined QoS requirements may be re-used for performing traffic influence as shown at 45.

The SEALDD client and SEALDD server may store the received and/or determined information. The stored information may be associated with a SEALDD session/traffic/flow identifier(s) such that the configuration parameters or determined parameters (e.g., buffering size, QoS) may be (e.g., uniquely) identified to (e.g., associated with) an XR flow from the XR session.

As shown at 43, the SEALDD client may use the information received in the request to configure the flow synchronization. Configuring flow synchronization may include, for example, any of configuring traffic filters at the WTRU for processing the downlink data received for a (e.g., each) flow (e.g., SEALDD packet decryption, flow alignment) and configuring the buffering space for a (e.g., each) synchronized flow. In an example, the SEALDD client may determine the buffering space (e.g., required) based on any of the XR flow characteristics and synchronization tolerance. In another example, the SEALDD client may determine the buffering space (e.g., required) based on the expected buffering space (e.g., needs) provided (e.g., indicated) by the SEALDD server.

As shown at 44a, the SEALDD client may send a (e.g., flow synchronization) response to the SEALDD server. As shown at 44b, the SEALDD server may send a (e.g., flow synchronization) response to the VAL server. The responses may respectively include an indication of whether the flow synchronization may have been configured at the SEALDD client (as shown at 44a) and at the SEALDD server (as shown at 44b). The responses may further include information about the determined buffering space (e.g., needs) and the determined QoS requirements e.g., determined as described herein with regards to 42a, 42b and 43.

As shown at 45, if the SEALDD server has determined QoS requirements for the individual XR flows, as shown at 42a, 42b, the SEALDD server may send a request to the 5GC to exercise traffic influence on the XR flows. For example, the SEALDD server may use the NEF/PCF/network resource management (NRM)/edge enabler server (EES) service for QoS adjustment as described in 3GPP TS 23.433 V19.3.0.

The SEALDD server may configure the QoS of the SEALDD data flow for data boosting (e.g., including a default QoS requirement corresponding to a default urgency value and one or more expedited QoS requirements corresponding to different urgency values). The SEALDD server may configure the tunnel endpoint on the SEALDD server to set an urgency indication in the outer header of the SEALDD data flow tunnel. The urgency indication may for example be an urgency header field. Initially, the tunnel endpoint may use the default urgency value, which may correspond to the default QoS requirement configured for the flow.

As shown at 46, upon receiving the flow synchronization response shown at 44b from the SEALDD server, the VAL server may send downlink flows to the VAL client using the SEALDD connection and the SEALDD client may perform downlink flow alignment according to the SEALDD flow synchronization configuration.

### SEALDD XR Traffic Synchronization Monitoring and Coordination

A procedure is described herein, allowing configuring XR flow synchronization monitoring. XR flow synchronization reports may be used to report flow alignment events that may be used to perform traffic influence with the underlying network (e.g., any of QoS, data boost).

FIG. 5 is a diagram illustrating an example procedure for performing SEALDD XR traffic synchronization monitoring and coordination.

As shown at 51, a XR flow synchronization may have been configured for the XR session between the VAL client and VAL server as described herein with the description of FIG. 4.

As shown at 52, the SEALDD server may send (e.g., configuration information indicating) a flow synchronization monitoring request to the SEALDD client. The SEALDD server may trigger the request based on local configuration, based on detecting traffic for the configured XR flows or based on a request from the VAL server (not shown on FIG. 5). The request may include a SEALDD session/traffic/flow identifier(s) e.g., along with the reporting requirements of associated flows. Reporting requirements may indicate to the SEALDD client the (e.g., buffering) event detection (e.g., parameters to be used) for triggering flow synchronization reports.

Flow synchronization reporting requirements may include any of (i) a time period (e.g., requirement) for sending reporting information at periodic time intervals, (ii) a synchronization requirement for sending reporting information on synchronization events (e.g., reporting on flow de-synchronized, on flow synchronized), (iii) a buffering requirement for sending reporting information on buffering events (e.g., reporting on any of buffer full, buffer empty, buffering threshold level reached, buffering fill rate exceeded, etc.). Any reporting requirement may be associated with a time duration (e.g., hysteresis) for triggering the report (e.g., only) after a period of time when a condition is detected. In an example, any reporting requirement may be associated with a time duration (e.g., hysteresis) for triggering the report based on the reporting requirement being met for the time duration.

As shown at 53, the SEALDD client may configure the flow synchronization monitoring according to the flow synchronization reporting requirements received at 52. The SEALDD client may use the SEALDD session/traffic/flow identifier(s) to identify the flows for which reporting may be requested and may use the flow synchronization reporting requirements to configure event detection.

As shown at 54, the SEALDD client may send a (e.g., flow synchronization monitoring) response to the SEALDD server. The response may indicate if the SEALDD client has configured the flow synchronization monitoring for the requested flows and according to the requested flow synchronization reporting requirements. In an example, if the request sent as shown at 52 was triggered by the VAL server (not shown on FIG. 5), the SEALDD server may send a response to the VAL server indicating if the SEALDD client has configured the flow synchronization monitoring.

As shown at 55, the SEALDD client may detect a (e.g., flow synchronization monitoring) event that may require triggering a report according to the flow synchronization reporting requirements. For example, the SEALDD client may detect that a buffering condition may be satisfied for a traffic flow (e.g., detect that buffering for a flow synchronization has reached a threshold level e.g., for a period of time) based on flow synchronization reporting requirements. The SEALDD client may trigger a flow synchronization report towards the SEALDD server based on the buffering condition being satisfied.

The SEALDD client may monitor the input (e.g., playback) buffer of a WTRU application. The SEALDD client may detect a misalignment (e.g., condition), e.g., a case where the buffered size of a component of a multiplexed flow is either larger or shorter than other components. The misalignment detection may be associated with a criticality level. The SEALDD client may determine the criticality based on e.g., any of timing, network conditions, amount of traffic. For example, a video buffer being reduced from two seconds to one and a half seconds during the course of one second may be classified as critical. For example, a buffer with a stable usage of three seconds of video and haptics data, and four seconds of audio may be classified as non-critical. The criticality level may be a Boolean or a number (such as e.g., a rating between one and ten). The criticality level can express (e.g., indicate) how urgent the response may be, from the standpoint of the SEALDD client.

As shown at 56, the SEALDD client may send a (e.g., flow synchronization monitoring) notification to the SEALDD server. The notification may include a (e.g., flow synchronization) report indicating the misalignment(s) (e.g., condition(s)) detected (e.g., as shown at 55) for flow(s) associated with a SEALDD session/traffic/flow identifier(s). For example, the SEALDD client may report that buffering for a flow synchronization has reached a threshold level (e.g., a first (e.g., high) threshold or a second (e.g., low) threshold) for a period of time indicating that the SEALDD client buffer for a given flow may be over-utilized or under-utilized. For example, the report may indicate that a flow over-utilizing buffering (e.g., above a threshold) may not be adversely impacted if it experienced more network delay or may indicate that a flow under-utilizing buffering (e.g., below a threshold) may not be adversely impacted if it experienced data boost.

The SEALDD client may include a criticality indication, which may include a level of criticality, in the flow synchronization monitoring notification to the SEALDD server.

As shown at 57, the SEALDD server may use the information received in the (e.g., flow synchronization) report and the information associated with the SEALDD session/traffic/flow identifier(s) (e.g., as shown at 42a, 42b of FIG. 4) to determine if a corrective action is to be performed. The SEALDD server may use the reporting information to re-evaluate the determined QoS.

In a first example, if the report indicates that a (e.g., given) flow is over-utilizing buffering (e.g., has crossed a first (e.g., high) buffering threshold, e.g., the amount of buffered data associated with the (e.g., given) flow being above the first (e.g., high) buffering threshold) for a (e.g., determined) amount of time, the SEALDD server may determine a (e.g., new) QoS value for the flow such that the network may apply more delay to the flow to reduce the buffering below the first (e.g., high) threshold. The determination of the (e.g., new) QoS value may be based on XR flow characteristics (e.g., any of a data rate, a periodicity, a burst size) and the over-buffering characteristics (e.g., a buffer size, a threshold level and an over-buffering time period) indicated in the report. The SEALDD server may compare the determined (e.g., new) QoS value to the initial QoS value applied to the flow, and if the determined (e.g., new) QoS value is different and lower, the SEALDD server may apply the determined (e.g., new) QoS value to the flow as a corrective measure (e.g., as shown at 58) to reduce the over-buffering condition (e.g., such that the over buffering condition may no longer be satisfied). In an example, determining a (e.g., new) QoS value may also apply to a flow that may cross a second (e.g., low) buffering threshold (e.g., a flow for which the amount of buffered data may be less than the second (e.g., low) buffering threshold), and a (e.g., new) QoS value may be a corrective measure to under-utilizing buffering.

In a second example, if the report indicates that a (e.g., given) flow is under-utilizing buffering (e.g., has crossed a second (e.g., low) buffering threshold, e.g., the amount of buffered data associated with the (e.g., given) flow being below the second (e.g., low) buffering threshold) for a (e.g., determined) amount of time, the SEALDD server may determine to apply a data boost operation to the flow. The data boost operation may indicate to the network to expedite the delivery of packets associated with the flow which may be a corrective measure to reduce the under-buffering condition (e.g., such that the under-buffering condition may no longer be satisfied).

In an example, the determination of whether to use traffic influence via QoS or via data boost to eliminate an under-buffering condition may be based on an algorithm. The determination may be based on whether the network (e.g., 5GC) supports of traffic influence via QoS and/or data boost.

In an example, an algorithm for the determination of whether to use traffic influence via QoS or via data boost may consider the reactiveness of method of traffic influence (e.g., via QoS versus via data boost). For example, performing traffic influence via QoS may have a slower reactiveness due to more signaling with the core network compared to performing traffic influence via data boost which may be (e.g., immediately) activated by marking packets to be influenced with a higher QoS.

In an example, an indication of criticality present in a (e.g., synchronization) report may provide an indication of the (e.g., required) reactiveness. For example, a higher level of criticality may indicate (e.g., to an algorithm or an implementation) to perform traffic influence via data boost to achieve higher reactiveness, and a lower level of criticality level may indicate that traffic influence via QoS may be performed.

The SEALDD server may use the criticality indication to determine the corrective action. For example:

For high criticality level notifications, the SEALDD server may determine which flow(s) may require a higher QoS treatment and may set a high urgency indication value on DL SEALDD packets that may include a PDU from this flow(s). The high urgency indication value may be maintained for a fixed duration, and/or until reception of another message from the SEALDD client, indicating that the issue may be fixed.

For low criticality level notifications, the SEALDD server may determine which flow(s) may require a higher or lower QoS treatment (e.g., lower or higher PDB), and may modify the QoS on these flows (e.g., using the AF session with QoS procedure). For example, the SEALDD server may reduce the QoS associated with a flow based on the principle that a flow over utilizing buffering may have a QoS that may be too high. Reducing a QoS may comprise increasing the PDB of the flow. A QoS being too high may refer to the fact that the PDB may be too small.

As shown at 58, the SEALDD server may send a request to the (e.g., 5GC) network based on the information in the report and the determined QoS requirements (e.g., as shown at 57).

In a first example, if the SEALDD server has determined to perform traffic influence via QoS, the SEALDD server may invoke the Nnef_AFsessionWithQoS_Update_Request API (e.g., may send a request message indicating invoking Nnef_AFsessionWithQoS_Update_Request API) as described in clause 4.15.6.6a of 3GPP TS 23.502 V19.1.0, and may provide (e.g., indicate) a new QoS reference. In a second example, if the SEALDD server has determined to perform traffic influence via QoS, the SEALDD server may invoke the Ncfp_PolicyAuthorization Update_Request API (e.g., may send a request message indicating invoking Ncfp_PolicyAuthorization Update_Request API) as described in clause 4.15.6.6a of 3GPP TS 23.502 V19.1.0 and may provide (e.g., indicate) a requested 5GS delay. For example, the SEALDD server may use the NEF/PCF/NRM/EES service for QoS adjustment as described in 3GPP TS 23.433 V19.3.0 to perform the QoS adjustment.

Embodiments described herein are not limited to the Nnef_AFsessionWithQoS_Update_Request and Nnef_AFsessionWithQoS_Update_Request examples and are applicable to any request message sent to any network element indicating a new QoS value to be applied by the network.

For example, if the SEALDD server has determined to perform traffic influence via data boost, the SEALDD server may mark packets such that packets may receive an (e.g., immediate) higher QoS treatment when being delivered by the network.

### Example Method for SEALDD Traffic Synchronization

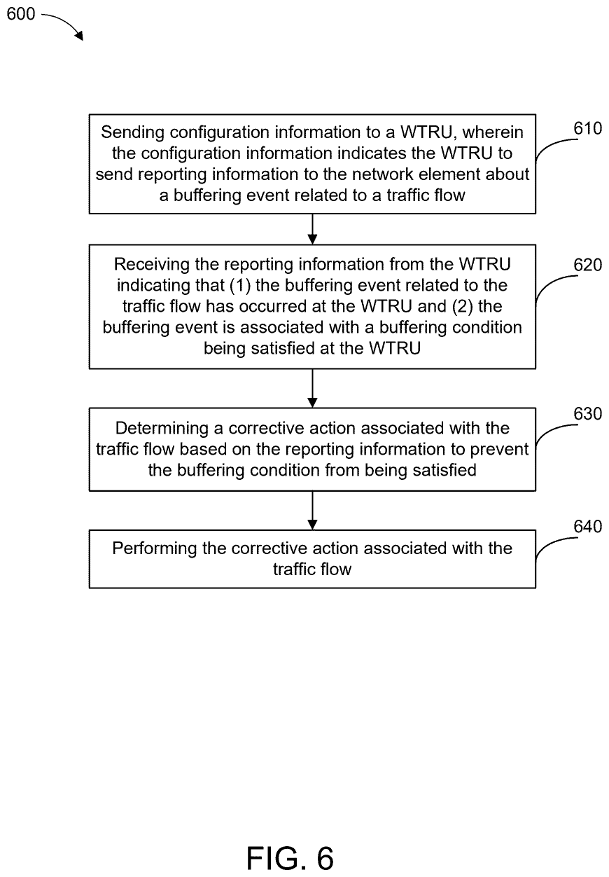

FIG. 6 is a diagram illustrating an example method 600 for SEALDD traffic synchronization in mobile networks, implemented in a network element. The network element may include circuitry including any of transmitter, a receiver, a processor, and a memory. The circuitry may be configured to carry out the method 600. As shown at 610, the method 600 may include sending configuration information to a WTRU. In various embodiments, the configuration information may indicate the WTRU to send reporting information to the network element about a buffering event related to (e.g., associated with) a traffic flow. As shown at 620, the method 600 may include receiving the reporting information from the WTRU indicating that (1) the buffering event related to the traffic flow may have occurred at the WTRU and (2) the buffering event may be associated with a buffering condition being satisfied at the WTRU. As shown at 630, the method 600 may include determining a corrective action associated with the traffic flow based on the reporting information to prevent the buffering condition from being satisfied. As shown at 640, the method 600 may include performing the corrective action associated with the traffic flow.

In various embodiments, the buffering condition may be satisfied at the WTRU based on an amount of data buffered at the WTRU being higher than a first threshold.

In various embodiments, the buffering condition may be satisfied at the WTRU based on the amount of data buffered at the WTRU being higher than the first threshold for more than an amount of time.

In various embodiments, the configuration information may indicate any of the first threshold and the amount of time.

In various embodiments, the buffering condition may be satisfied at the WTRU based on an amount of data buffered at the WTRU being lower than a second threshold.

In various embodiments, the buffering condition may be satisfied at the WTRU based on the amount of data buffered at the WTRU being lower than the second threshold for more than an amount of time.

In various embodiments, the configuration information may indicate any of the second threshold and the amount of time.

In various embodiments, the configuration information may indicate an identifier of the traffic flow.

In various embodiments, the configuration information may indicate to send the reporting information based on the buffering condition being satisfied at the WTRU.

In various embodiments, the buffering condition may be any of an over utilization buffering condition and an underutilization buffering condition.

In various embodiments, the reporting information may indicate a level of criticality.

In various embodiments, determining the corrective action associated with the traffic flow may comprise determining the corrective action associated with the traffic flow further based on the level of criticality.

In various embodiments, the method may further comprise determining, based on the reporting information, whether the buffering event corresponds to a buffer over utilization or to a buffer underutilization at the WTRU.

In various embodiments, determining the corrective action associated with the traffic flow may comprise determining the corrective action to be traffic influence via requesting a higher delay value to a network based on the buffer event corresponding to the buffer over utilization at the WTRU.

In various embodiments, requesting the higher delay value to the network may comprise sending a request to a network exposure function (NEF) of the network indicating a packet delay budget value corresponding to the higher delay value.

In various embodiments, requesting the higher delay value to the network may comprise sending a request to a policy control function (PCF) of the network indicating a requested 5G system delay corresponding to the higher delay value.

In various embodiments, determining the corrective action associated with the traffic flow may comprise determining the corrective action to be traffic influence via data boost based on the buffer event corresponding to the buffer underutilization at the WTRU.

In various embodiments, performing data boost may comprise marking packets of the traffic flow with an urgency identification to reduce a delay of the traffic flow.

In various embodiments, the network element may comprise a SEALDD server.

While not explicitly described, embodiments described herein may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, and a memory, the circuitry being operable (e.g., configured) to process the disclosed method, with a computer program product comprising program code instructions and with a non-transitory computer-readable storage medium storing program instructions.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

The content of each of the following references is incorporated by reference herein in its entirety:
3GPP TS 23.433, “Service Enabler Architecture Layer for Verticals (SEAL)—Data Delivery enabler for vertical applications”, V19.3.0
3GPP TS 23.501, “System architecture for the 5G System (5GS)”, V19.1.0
3GPP TS 23.222, “Functional Architecture and Information Flows to Support Common API Framework for 3GPP Northbound APIs”, V19.3.0
3GPP TS 23.502, “Procedures for the 5G System (5GS)”, V19.1.0

1. A network element comprising circuitry, including any of transceiver, a processor, and memory, configured to:
send configuration information to a wireless transmit/receive unit (WTRU), wherein the configuration information indicates to the WTRU to send reporting information to the network element about a buffering event related to a traffic flow;
receive, from the WTRU, the reporting information indicating that (1) the buffering event
related to the traffic flow has occurred at the WTRU and (2) the buffering event is associated with a buffering condition being satisfied at the WTRU;
determine a corrective action associated with the traffic flow based on the reporting information to prevent the buffering condition from being satisfied; and
perform the corrective action associated with the traffic flow.

2. The network element of claim 1, wherein the buffering condition is satisfied at the WTRU based on an amount of data buffered at the WTRU being higher than a first threshold.

3. The network element of claim 2, wherein the buffering condition is satisfied at the WTRU based on the amount of data buffered at the WTRU being higher than the first threshold for more than an amount of time.

4. The network element of claim 3, wherein the configuration information indicates any of the first threshold and the amount of time.

5. The network element of claim 1, wherein the buffering condition is satisfied at the WTRU based on an amount of data buffered at the WTRU being lower than a second threshold.

6. The network element of claim 5, wherein the buffering condition is satisfied at the WTRU based on the amount of data buffered at the WTRU being lower than the second threshold for more than an amount of time.

7. The network element of claim 6, wherein the configuration information indicates any of the second threshold and the amount of time.

8. The network element of claim 1, wherein the configuration information indicates an identifier of the traffic flow.

9. The network element of claim 1, wherein the configuration information indicates to send the reporting information based on the buffering condition being satisfied at the WTRU.

10. The network element of claim 1, wherein the reporting information indicates a level of criticality.

11. The network element of claim 10, wherein the circuitry is configured to determine the corrective action associated with the traffic flow based on the level of criticality.

12. The network element of claim 1, wherein the circuitry is configured to determine, based on the reporting information, whether the buffering event corresponds to a buffer over utilization or to a buffer underutilization at the WTRU.

13. The network element of claim 12, wherein the circuitry is configured to determine the corrective action associated with the traffic flow including to determine the corrective action to be traffic influence via requesting a higher delay value to a network based on the buffer event corresponding to the buffer over utilization at the WTRU.

14. The network element of claim 13, wherein the circuitry is configured to request the higher delay value to the network including to send a request to a network exposure function of the network indicating a packet delay budget value corresponding to the higher delay value.

15. The network element of claim 13, wherein the circuitry is configured to request the higher delay value to the network including to send a request to a policy control function of the network indicating a requested 5G system delay corresponding to the higher delay value.

16. The network element of claim 12, wherein the circuitry is configured to determine the corrective action associated with the traffic flow including to determine the corrective action to be traffic influence via data boost based on the buffer event corresponding to the buffer underutilization at the WTRU.

17. The network element of claim 16, wherein the circuitry is configured to perform a data boost including to mark packets of the traffic flow with an urgency identification to reduce a delay of the traffic flow.

18. The network element of claim 1, comprising a service enabler architecture layer for data delivery server.

19. A method implemented in a network element, the method comprising:
sending configuration information to a wireless transmit/receive unit (WTRU), wherein the configuration information indicates to the WTRU to send reporting information to the network element about a buffering event related to a traffic flow;
receiving, from the WTRU, the reporting information indicating that (1) the buffering event related to the traffic flow has occurred at the WTRU and (2) the buffering event is associated with a buffering condition being satisfied at the WTRU;
determining a corrective action associated with the traffic flow based on the reporting information to prevent the buffering condition from being satisfied; and
performing the corrective action associated with the traffic flow.

20. The method of claim 19, wherein the buffering condition is satisfied at the WTRU based on an amount of data buffered at the WTRU being higher than a first threshold.
